(19) United States
(12) Patent Application Publication
(10) Pub. No.: US 2024/0038441 A1
(43) Pub. Date: Feb. 1, 2024

(54) Transformer, Power Module and Switching Power Supply

(71) Applicant: Aplus Power Technology (Hangzhou) Co., Ltd., Hangzhou City (CN)

(72) Inventors: Lingfeng Jiang, Hangzhou City (CN); Changyun Xiao, Hangzhou City (CN)

(21) Appl. No.: 18/358,699

(22) Filed: Jul. 25, 2023

(30) Foreign Application Priority Data
Jul. 26, 2022 (CN) 202210886999.9

(51) Int. Cl. H01F 27/30; H01F 27/24; H01F 27/28

(52) U.S. Cl. CPC H01F 27/306; H01F 27/24; H01F 27/2823

(57) ABSTRACT

The disclosure provides a transformer, a power module and a switching power supply. The transformer comprises a magnetic core, a primary side winding and a secondary side winding; the magnetic core comprises a first cover plate, a second cover plate, a winding column and at least two side columns, and at least two side columns of the magnetic core; at least one of the side columns has a through channel, the primary side winding is wound around the winding column, and a lead wire of the primary side winding passes through the through channel; the lead wire of the secondary side winding passes through a gap formed by the at least two side columns. In the disclosure, the lead wire of the primary side winding can pass through the through channel, thereby saving space and improving power density of the switching power supply.

### RELATED APPLICATIONS

This application claims priority under 35 U.S.C. § 119 or 365 to China, Application No. 202210886999.9, filed Jul. 26, 2022. The entire teachings of the above application are incorporated herein by reference.

### TECHNICAL FIELD

The disclosure relates to the technical field of a transformer, and in particular to a transformer, a power module and a switching power supply.

### BACKGROUND

With the increasing of power density of a switching power supply, the components of the switching power supply are placed more and more compactly, and how to effectively use space is one of the important means to improve the power density. At present, as shown in FIG. 1, the transformer in the switching power supply usually uses three-layer insulated wires as a primary side winding in the case of low-voltage output, and a magnetic core is placed on the side of a secondary side winding. A lead wire of the primary side winding is led out from a gap formed by a side column of the magnetic core and is pulled apart from the secondary side winding by a sufficient safety distance. In this case, the lead wire of the primary side winding is close to the outgoing wire of the side column of the magnetic core, which occupies a certain space and is not conducive to increasing the power density.

### SUMMARY

An object of the present disclosure is to provide a transformer, in which a through channel is provided on a side column of a magnetic core, and a lead wire of a primary side winding can pass through the through channel, thereby saving space and improving power density of a switching power supply. It is another object of the present disclosure to provide a power module. It is a further object of the present disclosure to provide a switching power supply.

In order to achieve the above objects, an aspect of the disclosure discloses a transformer, comprising a magnetic core, a primary side winding and a secondary side winding. The magnetic core comprises a first cover plate, a second cover plate, a winding column and at least two side columns, and the first cover plate and the second cover plate are respectively connected with top and bottom surfaces of a winding column and at least two side columns of the magnetic core.

At least one of the side columns has a through channel, the primary side winding is wound around the winding column, and a lead wire of the primary side winding passes through the through channel.

The lead wire of the secondary side winding passes through a gap formed by the at least two side columns.

Alternatively, the magnetic core comprises two side columns.

The first cover plate and the second cover plate respectively comprise two opposite long sides and two opposite short sides.

The two side columns are oppositely disposed and respectively connected with the first cover plate and the corresponding long sides of the first cover plate; or the two side columns are oppositely disposed and respectively connected with the first cover plate and the corresponding short sides of the first cover plate.

Alternatively, the two side columns are respectively provided with the through channels.

Alternatively, the two lead wires of the primary side winding pass through the through channel of one of the two side columns.

Alternatively, the primary side winding comprises a plurality of first windings, and the lead wire of each first winding passes through the same through channel.

Alternatively, a chamfer is formed at the through channel of the side column.

Alternatively, a skeleton sleeved on the winding column is further included, and the primary side winding and the secondary side winding are wound around the skeleton.

Alternatively, a current transformer arranged on the lead wire of the primary side winding is further included.

The present disclosure further discloses a power module comprising the transformer as described above.

The present disclosure further discloses a switching power supply comprising a power module as described above.

The transformer of the disclosure comprises a magnetic core, a primary side winding and a secondary side winding. Wherein, the magnetic core comprises a first cover plate, a second cover plate, a winding column and at least two side columns, and the first cover plate and the second cover plate are respectively connected with top and bottom surfaces of a winding column and at least two side columns of the magnetic core. At least one of the side columns has a through channel, the primary side winding is wound around the winding column, and a lead wire of the primary side winding passes through the through channel. The lead wire of the secondary side winding passes through a gap formed by the at least two side columns. In the present disclosure, at least one side column of the magnetic core of the transformer has a through channel. Thus, the lead wire of the primary side winding in the transformer can pass through the through channel in the side column. Therefore, the lead wire of the primary side winding in the transformer of the present disclosure can pass through the through channel of the side column without being drawn out from the gap formed by the side column of the magnetic core, so that the structure of the transformer is more compact, which is advantageous for increasing the power density of the switching power supply using the transformer. In addition, a through channel is arranged on the side column of the transformer, and heat generated in the operation of the transformer can be partially diffused to the outside of the transformer from the through channel, so that the heat dissipation capability of the transformer can be enhanced.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

In order to more clearly explain the embodiments of the disclosure or the technical solution in the prior art, drawings that need to be used in the description in embodiments or the prior art will be simply introduced below, obviously the drawings in the following description are merely some examples of the disclosure, for persons ordinarily skilled in the art, it is also possible to obtain other drawings according to these drawings without making creative efforts.

FIG. 1 shows a schematic diagram of a transformer in the prior art;

FIG. 2 shows a schematic diagram of a specific embodiment of a transformer according to the disclosure;

FIG. 3 is a schematic diagram of a side column provided with a through channel according to a specific embodiment of the transformer of the present disclosure;

FIG. 4 is a schematic diagram of two side columns provided with through channels according to a specific embodiment of the transformer of the present disclosure;

FIG. 5 is a schematic diagram showing that a transformer according to an embodiment of the present disclosure includes a plurality of winding columns and one side column is provided with a through channel;

FIG. 6 is a schematic diagram showing that a transformer according to an embodiment of the present disclosure includes a plurality of winding columns and two side columns are provided with through channels;

FIG. 7 is a schematic diagram showing a specific embodiment of the transformer according to the present disclosure includes a skeleton;

FIG. 8 shows an exploded view of a specific embodiment of the transformer according to the present disclosure including a skeleton;

FIG. 9 is a schematic diagram showing a specific embodiment of the transformer according to the present disclosure including a current transformer.

### REFERENCE NUMERALS

11. magnetic core; 12. primary side winding; 13. secondary side winding; 121. lead wire; 131. pin;
21. magnetic core; 22. primary side winding; 23. secondary side winding; 221. lead wire; 231. pin; 211. first cover plate; 212. second cover plate; 213. winding column; 214. side column; 215. through channel; 216. chamfer; 24. skeleton; 25. current transformer; 201, 202, 205, 206: long sides; 203, 204, 207, 208: short sides.

### DETAILED DESCRIPTION

A description of example embodiments follows.

Hereinafter the technical solution in the embodiments of the present disclosure will be described clearly and integrally in combination with the accompanying drawings in the embodiments of the present disclosure, and obviously the described embodiments are merely part of the embodiments, not all of the embodiments. Based on the embodiments of the present disclosure, all other embodiments that are obtained by persons skilled in the art without making creative efforts fall within the protection scope of the present disclosure.

It should be noted that the terms “first,” “second” and the like in the description and claims of the present disclosure and in the above-mentioned drawings are used to distinguish between similar objects and are not necessarily used to describe a particular order or precedence. It should be understood that the data so used may be interchanged where appropriate for the purpose of the embodiments of the present disclosure described herein. Furthermore, the terms “comprising” and “having” and any variations thereof are intended to cover non-exclusive inclusions, such as, for example, a process, a method, a system, a product or a device comprising a series of steps or units need not to be limited to those steps or units that are clearly listed, but may include other steps or units that are not explicitly listed or inherent to these processes, methods, products or devices.

In the present disclosure, the orientation or positional relationship indicated by the terms “on”, “under”, “left”, “right”, “front”, “back”, “top”, “bottom”, “inside”, “outside”, “middle”, “vertical”, “horizontal”, “transverse”, “longitudinal” and the like is based on the orientation or positional relationship shown in the drawings. These terms are mainly intended to better describe the present disclosure and its embodiments and are not intended to limit that the indicated devices, elements or constituents must have a particular orientation, or be constructed and operated in a particular orientation.

The positional relationship such as “parallel” or “vertical” includes not only the positional relationship of exactly “parallel” or “vertical,” but also the positional relationship that the angle deviation relative to exactly “parallel” or “vertical” is within the preset deviation range. Also, in addition to being used to represent an orientation or positional relationship, some of the above terms may also be used to indicate other meanings. For example, the term “on” may also be used in some cases to denote a certain attachment or connection. The specific meanings of these terms in the present disclosure may be understood by those ordinarily skilled in the art as the case may be.

In addition, the terms “installation”, “setting”, “being provided with”, “connecting”, “connected”, “sleeving” should be understood broadly. For example, the connection may be a fixed connection, a detachable connection or an integrated construction, or may be a mechanical connection or an electrical connection, or may be a direct connection, or may be an indirect connection through an intermediary, or an internal communication between two devices, elements or constituents. The specific meanings of the above terms in the present disclosure may be understood by those ordinarily skilled in the art as the case may be.

It should be noted that the embodiments in the present disclosure and the features in the embodiments can be combined with each other without conflict. Hereinafter, the present disclosure will be described in detail with reference to the drawings and in connection with embodiments.

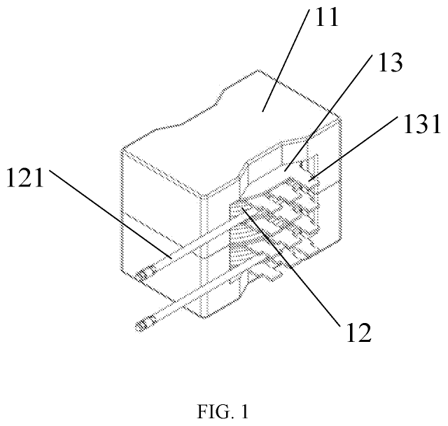

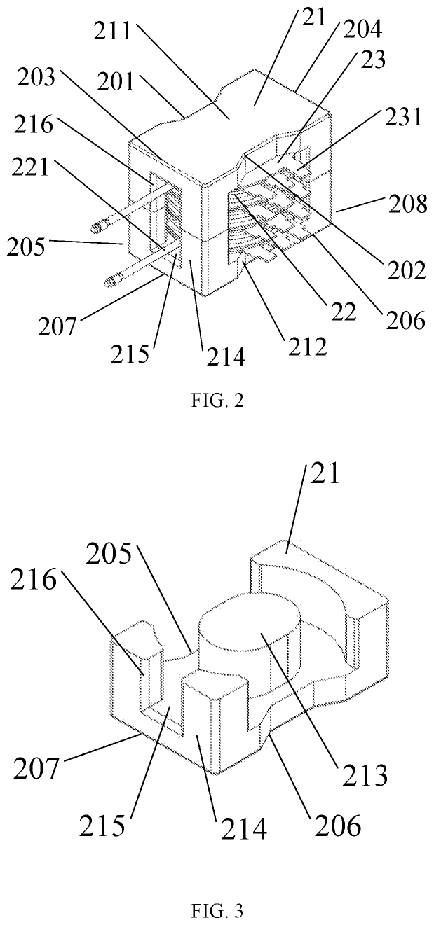

In the prior art, as shown in FIG. 1, the transformer in the switching power supply includes a magnetic core 11, a primary side winding 12 and a secondary side winding 13. Wherein, the secondary side winding 13 includes a pin 131 extending out of a gap formed by a side column of the magnetic core 11. Both ends of the primary side winding 12 are respectively lead wires 121, and the lead wires 121 and the pin 131 of the secondary side winding 13 pass through a gap formed by the side column of the magnetic core 11. On this basis, in order to separate the lead wire 121 of the primary side winding 12 from the pin 131 of the secondary side winding 13 by a sufficient safety distance, the lead wire 121, which is required to pass through the primary side winding 12 out of the gap formed by the side column, is bent and extends along the surface of the magnetic core 11 in the direction away from the secondary side winding 13 after it passes through. Therefore, in order to ensure the safety of the transformer, it is necessary to make the lead wire 121 of the primary side winding 12 exit from the side column near the magnetic core 11, such that the primary side winding 12 needs a certain outgoing space, which increases the space occupied by the transformer and is not conducive to increasing the power density. In addition, there is also a risk that the lead wire 121 of the primary side winding 12 passing through the gap formed by the side column interferes with other components. Based on this, according to an aspect of the present disclosure, the present embodiment discloses a transformer. As shown in FIG. 2, in the embodiment, the transformer includes a magnetic core 21, a primary side winding 22 and a secondary side winding 23.

Wherein, the magnetic core 21 includes a first cover plate 211, a second cover plate 212, a winding column 213, and at least two side columns 214. The first cover plate 211 and the second cover plate 212 are respectively connected to top and bottom surfaces of the winding column 213 and the at least two side columns 214 of the magnetic core 21.

At least one of the side columns 214 has a through channel 215, the primary side winding 22 is wound around the winding column 213, and a lead wire 221 of the primary side winding 22 passes through the through channel 215.

The lead wire 221 of the secondary side winding 23 passes through a gap formed by the at least two side columns 214.

The transformer of the disclosure comprises a magnetic core 21, a primary side winding 22 and a secondary side winding 23. Wherein, the magnetic core 21 includes a first cover plate 211, a second cover plate 212, a winding column 213, and at least two side columns 214. The first cover plate 211 and the second cover plate 212 are respectively connected to top and bottom surfaces of the winding column 213 and the at least two side columns 214 of the magnetic core 21. At least one of the side columns 214 has a through channel 215, the primary side winding 22 is wound around the winding column 213, and a lead wire 221 of the primary side winding 22 passes through the through channel 215. The lead wire 221 of the secondary side winding 23 passes through a gap formed by the at least two side columns 214.

In the present disclosure, at least one side column 214 of the magnetic core 21 of the transformer has a through channel 215. Thus, the lead wire 221 of the primary side winding 22 in the transformer can pass through the through channel 215 in the side column 214. Therefore, the lead wire 221 of the primary side winding 22 in the transformer of the present disclosure can pass through the through channel 215 of the side column 214 without being drawn out from the gap formed by the side column 214 of the magnetic core 21, so that the structure of the transformer is more compact, which is advantageous for increasing the power density of the switching power supply using the transformer. In addition, the lead wire 221 of the primary side winding 22 and the pin 231 of the secondary side winding 23 pass through from different directions and are separated by part of the side column 214, which can ensure that the lead wire 221 of the primary side winding 22 is separated from the pin 231 of the secondary side winding 23 by a sufficient safety distance, and to some extent, the risk that the lead wire 221 interferes with other components is also avoided. In addition, a through channel 215 is arranged on the side column 214 of the transformer, and heat generated in the operation of the transformer can be partially diffused to the outside of the transformer from the through channel 215, so that the heat dissipation capability of the transformer can be enhanced.

In an alternative embodiment, the magnetic core 21 includes two side columns 214. Specifically, it can be understood that, in order to realize purposes of the outgoing of the lead wire 221 of the primary side winding 22 and the outgoing of the pin 231 of the secondary side winding 23, and to improve the heat dissipation of the transformer, the magnetic core 21 of the transformer includes a first cover plate 211, a second cover plate 212, a winding column 213, and two side columns 214. The top and bottom surfaces of the winding column 213 and the two side columns 214 are connected to the first cover plate 211 and the second cover plate 212, respectively, and the two side columns serve as connecting and supporting functions. In an alternative embodiment, the first cover plate 211 and the second cover plate 212 respectively comprise two opposite long sides and two opposite short sides.

Wherein, the two side columns 214 are oppositely disposed, and are respectively connected to the first cover plate 211 and the corresponding long sides of the first cover plate 211; or the two side columns 214 are oppositely disposed, and are respectively connected to the first cover plate 211 and the corresponding short sides of the first cover plate 211.

Specifically, it will be appreciated that the transformer is generally a rectangular parallelepiped. Accordingly, the first cover plate 211 and the second cover plate 212 are also configured as rectangular parallelepipeds, and the first cover plate 211 and the second cover plate 212 include opposite two long sides (201, 202, 205, 206) and opposite two short sides (203, 204, 207, 208), respectively.

In order to realize the connecting and supporting functions of the side columns 214, the two side columns 214 may be disposed at two opposite short sides of the first cover plate 211 and the second cover plate 212, respectively. That is, one side column 214 is arranged at one short side of the first cover plate 211 and the second cover plate 212, and upper and lower surfaces of the side column 214 are connected to one short side 203 of the first cover plate 211 and the corresponding short side 207 of the second cover plate 212, respectively, the other side column 214 is arranged at the other short side of the first cover plate 211 and the second cover plate 212, and upper and lower surfaces of the side column 214 are connected to the other short side 204 of the first cover plate 211 and the corresponding short side 208 of the second cover plate 212, respectively.

Of course, the two side columns 214 may also be respectively disposed on the two opposite long sides of the first cover plate 211 and the second cover plate 212. That is, one side column 214 is arranged at one long side of the first cover plate 211 and the second cover plate 212, and upper and lower surfaces of the side column 214 are connected to one long side 201 of the first cover plate 211 and the corresponding long side 205 of the second cover plate 212, respectively; the other side column 214 is arranged at the other long side of the first cover plate 211 and the second cover plate 212, and upper and lower surfaces of the side column 214 are connected to the other long side 202 of the first cover plate 211 and the corresponding long side 206 of the second cover plate 212, respectively.

It should be noted that in other embodiments, the first cover plate 211 and the second cover plate 212 can also be set to other shapes, as long as the side column and the winding column can be connected to the first cover plate 211 and the second cover plate 212 respectively to form the magnetic core, and the present disclosure is not limited thereto.

In an alternative embodiment, the two side columns 214 are respectively provided with the through channels 215.

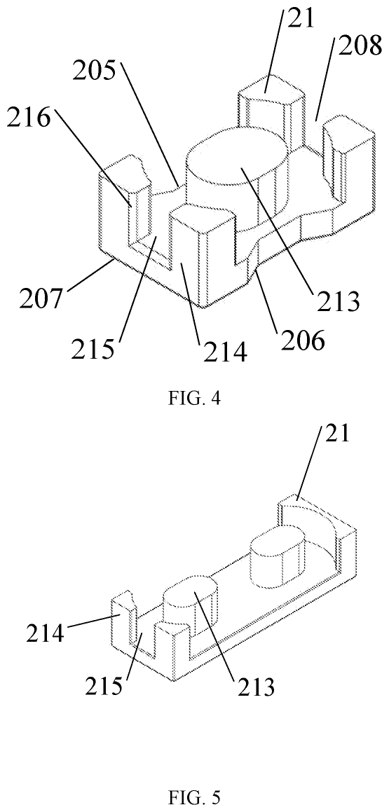

Specifically, it can be understood that when the magnetic core 21 includes two side columns 214, a through channel 215 may be provided in one of the two side columns 214, as shown in FIG. 3. It is also possible to provide through channels 215 in both of the side columns 214, as shown in FIG. 4. When the two side columns 214 are both provided with the through channels 215, the lead wires 221 at both ends of the primary side winding 22 can pass through any of the through channels 215 according to actual requirements, thereby improving the versatility of the magnetic core 21, which is convenient for the magnetic core 21 to be used in transformers of different configurations.

It should be noted that in the embodiment, a part of the winding column and the side column can be formed integrally with the first cover plate to obtain a first portion, the other part of the winding column and the side column is formed integrally with the second cover plate to obtain a second portion, and then the first portion and the second portion are spliced to obtain a complete transformer. Of course, in other embodiments, the transformer can also be obtained by forming the first cover plate, the second cover plate, the winding column and the side column respectively and then connecting them integrally, and other production methods, which are not limited in the present disclosure.

In an alternative embodiment, the two lead wires 221 of the primary side winding 22 pass through the through channel 215 of one of the two side columns 214.

Specifically, it can be understood that two lead wires 221 are led out from both ends of the primary side winding 22. The two lead wires 221 can simultaneously pass through the through channel 215 formed in any one of the side columns 214, thus it is not necessary to consider the outlet space of the primary side winding 22 in the arrangement of the transformer, which reduces the space occupation of the transformer, is advantageous in reducing the volume of the switching power supply or other circuits provided with the transformer, and improves the power density. Of course, according to different actual requirements, if two or more side columns 214 are formed with the through channels 215, the two lead wires 221 of the primary side winding 22 can also respectively pass through different through channels 215, and the through channels 215 through which the lead wires 221 pass can be set by those skilled in the art according to different actual requirements, which is not limited in the present disclosure. In an alternative embodiment, the primary side winding 22 comprises a plurality of first windings, and the lead wire 221 of each first winding passes through the same through channel 215.

Specifically, it is understood that the primary side winding 22 in the transformer may be configured to include a plurality of first windings, and there may be one or more side columns 214 provided with the through channels 215. Accordingly, the lead wire of each primary first winding in the transformer can pass through any one of the through channels 215 according to actual requirements, which greatly improves the flexibility of the lead wires 221 of the primary side winding 22 of the transformer to pass through, so that the structure of the magnetic core 21 can be adapted to the arrangement of the transformer with different structures.

In an alternative embodiment, the secondary side winding 23 may include a plurality of second windings each having a pin extending through a gap formed by the side column 214 of the magnetic core. Therefore, the pin 231 of the secondary side winding 23 and the lead wire 221 of the primary side winding 22 respectively pass through the through channel 215 on the side columns 214 and the gap between the side columns 214, in different passing paths, thereby avoiding the risk of interference between the lead wire of the primary side winding and the pin of the secondary side winding.

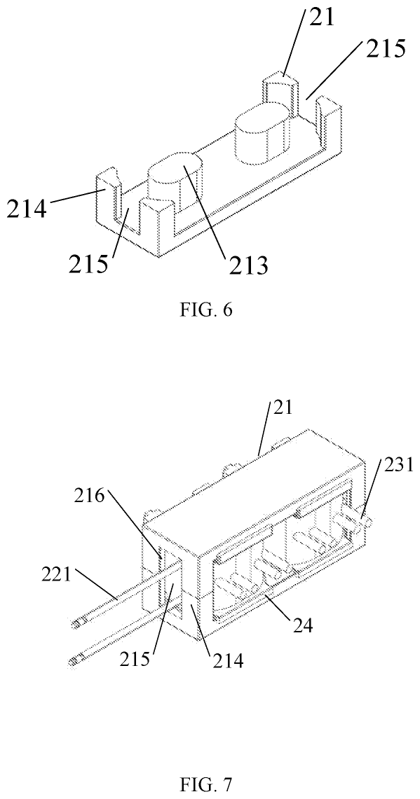

In an alternative embodiment, as shown in FIGS. 5 and 6, the winding column 213 may be in plural.

Specifically, it can be understood that a plurality of different primary side windings 22 and secondary side windings 23 may be integrated in the transformer. The primary side windings 22 may include a plurality of first windings, and the secondary side winding 23 may include a plurality of second windings. Therefore, in one or more embodiments, according to actual requirements, the winding column 213 can be configured in plural to meet the configuration requirements of transformers with different structures.

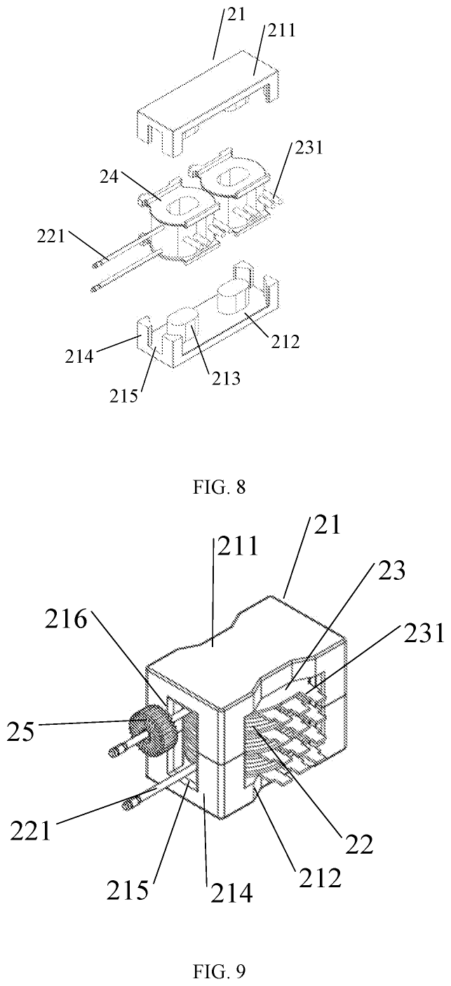

In an alternative embodiment, as shown in FIGS. 7 and 8, the transformer further includes a skeleton 24 sleeved on the winding column 213, and the primary side winding 22 and the secondary side winding 23 are wound around the skeleton 24.

Specifically, it can be understood that in one or more embodiments, the skeleton 24 may be disposed in the magnetic core 21 of the transformer, and the primary side winding 22 and the secondary side winding 23 may be wound around the skeleton 24. The skeleton 24 is generally of an insulating material, and can insulate the primary side winding 22 and the secondary side winding 23 from the first cover plate 211 and the second cover plate 212.

In an alternative embodiment, a chamfer 216 is formed at the through channel 215 of the side column 214.

Specifically, it can be understood that the lead wire 221 of the primary side winding 22 needs to pass through the through channel 215 in the side column 214. In this embodiment, chamfers 216 may be formed at openings of both ends of the through channel 215 of the side column 214 to prevent the through channel 215 from damaging the primary side winding 22. In an alternative embodiment, outer surface of the primary side winding 22 and the secondary side winding 23 is provided with an insulating layer.

Specifically, it can be understood that the outer surface of the primary side winding 22 and the secondary side winding 23 is provided with an insulating layer, which can insulate the primary side winding 22 and the secondary side winding 23 from each other, and can also insulate the primary side winding 22 and the secondary side winding 23 from the magnetic core 21, thereby preventing problems such as a short circuit from occurring.

In an alternative embodiment, as shown in FIG. 9, the transformer further includes a current transformer 25 arranged on the lead wire 221 of the primary side winding 22, to realize functions such as protection or measurement of the circuit.

Based on the same principle, this embodiment further discloses a power module. The power module includes the transformer as described in this embodiment.

Specifically, the power module may include the transformer of this embodiment, and may further include a capacitor, a switching element, and other devices.

Since the power module solves the problem in accordance with the principle similar to that of the transformer described above, the implementation of the power module may be found by referring to the implementation of the transformer, and is not repeated herein.

Based on the same principle, this embodiment further discloses a switching power supply. The switching power supply includes a power module as described in this embodiment.

It can be appreciated that the switching power supply may include a main circuit board on which a power module may be provided. Alternatively, the power module may be first disposed on the module circuit board, and then the module circuit board is disposed on the main circuit board to form the switching power supply, so that the power module of this embodiment is disposed in the switching power supply.

Since the switching power supply solves the problem in accordance with the principle similar to that of the transformer described above, the implementation of the switching power supply may be found by referring to the implementation of the transformer, and is not repeated herein.

The various embodiments in the specification are described in a progressive manner, and the same or similar parts between the various embodiments may be referred to each other, and each embodiment focuses on the differences from the other embodiments. In particular, the system embodiment is simply described since it is substantially similar to the method embodiment, and please refer to the description of the method embodiment for the relevant content.

The above description is merely an embodiment of the present disclosure, and is not intended to limit the present disclosure. Various modifications and variations may be made to the present disclosure by those skilled in the art. Any modifications, equivalents, improvements, etc. made within the spirit and scope of the present disclosure are intended to be included within the scope of the claims of the present disclosure.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A transformer, wherein comprising a magnetic core, a primary side winding and a secondary side winding;
the magnetic core comprises a first cover plate, a second cover plate, a winding column and at least two side columns, and the first cover plate and the second cover plate are respectively connected with top and bottom surfaces of a winding column and at least two side columns of the magnetic core;
at least one of the side columns has a through channel, the primary side winding is wound around the winding column, and a lead wire of the primary side winding passes through the through channel;
the lead wire of the secondary side winding passes through a gap formed by the at least two side columns.

2. The transformer according to claim 1, wherein, the magnetic core comprises two side columns;
the first cover plate and the second cover plate respectively comprise two opposite long sides and two opposite short sides;
the two side columns are oppositely disposed and respectively connected with the first cover plate and the corresponding long sides of the first cover plate; or
the two side columns are oppositely disposed and respectively connected with the first cover plate and the corresponding short sides of the first cover plate.

3. The transformer according to claim 2, wherein, the two side columns are respectively provided with the through channels.

4. The transformer according to claim 3, wherein, the two lead wires of the primary side winding pass through the through channel of one of the two side columns.

5. The transformer according to claim 1, wherein, the primary side winding comprises a plurality of first windings, and the lead wire of each first winding passes through the same through channel.

6. The transformer according to claim 1, wherein, a chamfer is formed at the through channel of the side column.

7. The transformer according to claim 1, wherein further comprising a skeleton sleeved on the winding column, and the primary side winding and the secondary side winding are wound around the skeleton.

8. The transformer according to claim 1, wherein further comprising a current transformer arranged on the lead wire of the primary side winding.

9. A power module, wherein comprising a transformer according to claim 1.

10. A switching power supply, wherein comprising a power module according to claim 9.
